(19) United States
(12) Patent Application Publication
(10) Pub. No.: US 2003/0220593 A1
(43) Pub. Date: Nov. 27, 2003

(54) Touch control foot spa

(75) Inventor: Kevin Joseph Morton, Fairfield, CT (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: CONAIR CORPORATION

(21) Appl. No.: 10/419,065

(22) Filed: Apr. 18, 2003

Related U.S. Application Data
(60) Provisional application No. 60/373,545, filed on Apr. 18, 2002.

(51) Int. Cl. A61H 35/00; A47K 3/022

(52) U.S. Cl. 601/15; 601/17; 601/22; 601/154; 601/158; 4/622

(57) ABSTRACT

A foot spa and a method for controlling the foot spa is provided. The foot spa has a housing defining a reservoir for locating feet and a touchpad control unit for controlling a function of the foot spa.

### BACKGROUND OF THE INVENTION

1. Field of the Invention

The present invention relates to a foot spa. More particularly, the present invention relates to a foot spa having a touchpad control unit for controlling the operation of the foot spa.

2. Description of the Related Art

In the prior art, there are known foot therapy massage devices for providing a variety of vibrating massage sensations, both with and without liquid, and aerated bubble massage sensations, either alone or in combination. Generally, a common objective in the prior art devices is to provide relief to a user by providing soothing, therapeutic stimuli to the user's feet.

Operation of the prior art foot therapy devices is generally characterized by inconvenient, manually actuated mechanical controls located on the foot therapy device. The mechanical controls of such foot therapy devices are prone to failure or degradation. Additionally, mechanical switches may be troublesome to operate by intended users of the foot therapy device. For example, a user of the foot therapy device may have trouble grasping and turning a control knob located on the device. Thus, any soothing, and relaxing therapeutic benefit(s) gained by using the foot therapy device must be interrupted in order to control the device.

Therefore, there exists a need to provide a reliable foot spa that is easily controlled and operated.

### SUMMARY OF THE INVENTION

It is an object of the present invention to provide a foot spa having a touchpad control unit.

It is another object of the present invention to provide a foot spa in which the touchpad control unit is easily manipulated by a user.

It is yet another object of the present invention to provide such a foot spa having a touchpad control unit that facilitates controlling operation of the foot spa by functions accessed thereby, while maintaining the relaxing context induced by the operation of the foot spa.

It is still a further object of the present invention to provide such a foot spa that has a housing defining a reservoir for retaining a volume of liquid, a touchpad control unit for controlling a plurality of functions of the foot spa, and a lid partially covering a portion of the reservoir.

The above and other objects, advantages, and benefits of the present invention will be understood by reference to following detailed description and appended sheets of drawings.

### BRIEF DESCRIPTION OF THE DRAWINGS

FIG. 1 is a perspective view of a foot spa having a touchpad control unit in accordance with the present invention, including an exemplary bracket for retaining a plurality of attachments for use in conjunction with the foot spa;

FIG. 2 is a top plan view of the foot spa of FIG. 1;

FIG. 3 is a top view of the exemplary touchpad control unit shown in FIG. 1; and

FIG. 4 is a cross-sectional detail of the switch assembly of the touchpad control unit of the foot spa of FIG. 1.

### DETAILED DESCRIPTION OF THE INVENTION

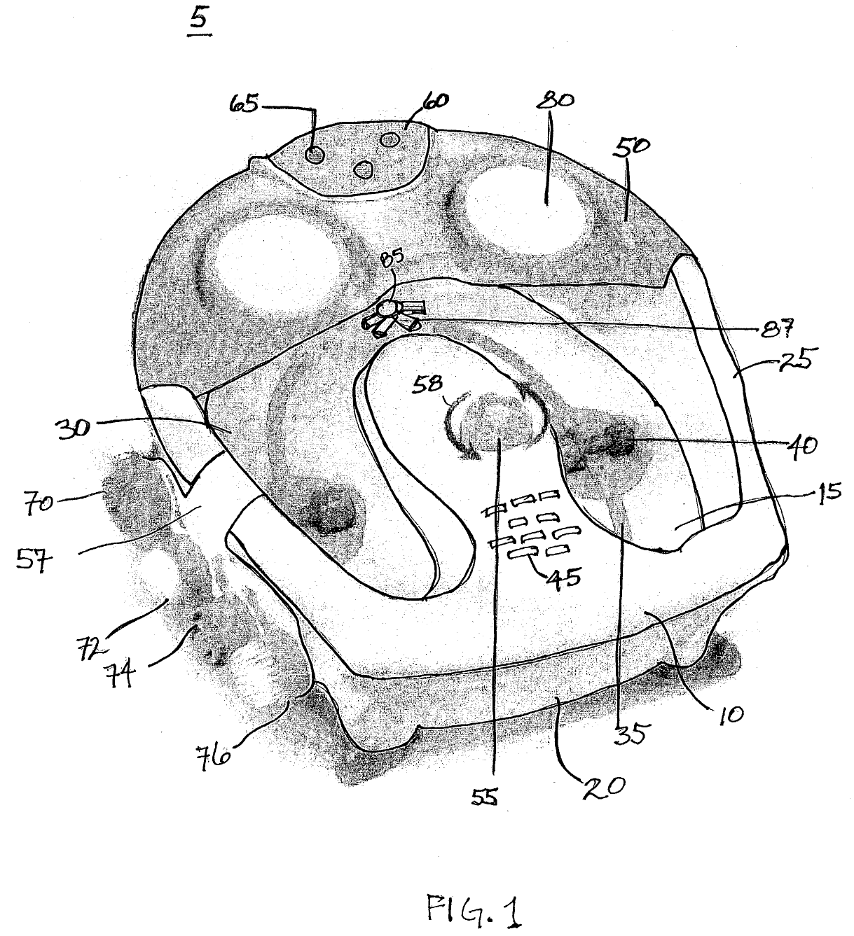

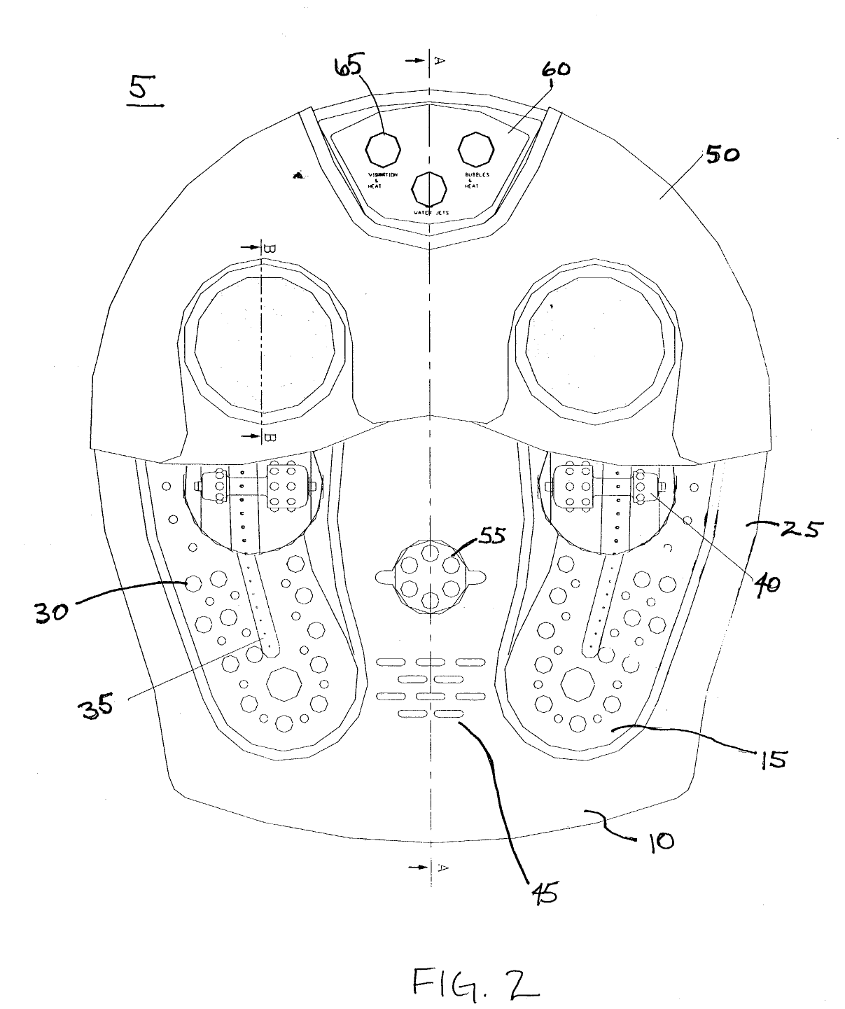

Referring to the drawings and in particular FIGS. 1 and 2, there is provided a foot spa generally represented by reference numeral 5. Foot spa 5 has a housing 10. Housing 10 has a floor or bottom wall 15, opposing sidewalls 20 (including a front sidewall, not shown), and a top wall 25. Bottom wall 15, top wall 25, and sidewalls 20 (preferably all three) define a reservoir for receiving feet placed therein for therapeutic massaging. The reservoir may optionally contain a liquid such as water.

Housing 10 has a number of massage nodules 30 disposed on bottom wall 15, a number of aeration outlets 35 located at least on a portion of bottom wall 15, a pair of massaging rollers 40 positioned on bottom wall 15 and preferably disposed over the plurality of aeration outlets 35, and a heel rest 45 and splash guard 50 positioned on top wall 25. Housing 10 also preferably includes an attachment receptor (not shown) for accepting a stimulus attachment 55 thereon.

It should be appreciated that the particular size and location of, for example, massage nodules 30, aeration outlets 35, and massaging rollers 40 may be varied without departing from the scope of the present invention.

Foot spa 5 has a touchpad control unit 60 for controlling the operational features of foot spa 5. Touchpad control unit 60 preferably includes a plurality of touch-sensitive controls 65. Each touch-sensitive control 65 may have one or more operational functions associated therewith.

Each massaging roller 45 is preferably detachably attached to bottom wall 15 for selectively providing therapeutic stimuli such as a kneading action to feet placed in the reservoir. Massaging rollers 40 have a rotating portion for providing a kneading sensation as a foot is moved thereupon, and aeration outlets matingly interfaced with aeration outlets 35 disposed in bottom wall 15. The aeration outlets of massaging rollers 40 provide an outlet for dispensing invigorating air bubbles into the water (in the instance water is in the reservoir and a “bubbles” function is activated).

In one aspect of the present invention, the attachment receptor (not shown) has a spinning foot stimulus attachment 55 disposed thereon for, at a user's option, providing therapeutic stimulus to a foot placed upon stimulus attachment 55. Stimulus attachment 55 may selectively rotate to provide the therapeutic stimulus. Rotation of stimulus attachment 55 is depicted by arrows 58.

It should be understood that the direction, rate, and sequence of rotary motion of the stimulus attachment may be varied in a selective or predetermined manner within the scope of the present invention.

In one embodiment of the present invention, stimulus attachment 55 is selectively rotated, as indicated by arrows 58, in response to application of a downward pressure on stimulus attachment 55. Stimulus attachment 55 is preferably activated, that is, set into a spinning or rotating motion, in response to being depressed. Accordingly, stimulus attachment 55 may be actuated for rotating operation by being depressed by a user's foot.

Heel rest 45 is provided to, inter alia, facilitate the placement of the foot on stimulus attachment 55 by providing a slip-resistant surface for the foot to rest upon. Heel rest 45 is preferably located on upper wall 25 a spaced distance away from massage attachment 55 such that, preferably, the user's foot placed on heel rest 45 can be stimulated by massage attachment 55. Heel rest 55 preferably extends over at least a portion of top wall 25 and is sized to accommodate the stimulation of feet of varying sizes placed on the heel rest and simultaneously massaged by massaging attachment 55. Heel rest can include a raised surface treatment or a textured relief (i.e., depression) surface treatment.

Heel rest 45 may also operate to provide a convenient resting location for supporting the foot of a user while, for example, massaging only one foot and/or drying one foot after a wet foot spa treatment.

FIG. 1 also shows a plurality of exemplary stimulus attachments for optional use in conjunction with foot spa 5. The stimulus attachments are retained in bracket 57 that optionally attaches to side wall 20 as shown. The stimulus attachments include, for example, a spike attachment 70, a pumice stone 72, a massager 74, and a brush 76. However, other stimulus attachments can be used in connection with foot spa 5, alone or in combination with those lustrated herein.

Each of stimulus attachments 70, 72, 74, and 76 may be positioned on the attachment receptor for selective rotation thereof in a manner similar, for example, to the rotational operation of stimulus attachment 55 discussed above. In one aspect of the present invention, rotation of the stimulus attachments may be activated upon depression of the stimulus attachment for the duration of the depressing force, for a timed length of operation (e.g., one minute), and a predetermined sequence of movements including speed, direction, duration, and type (e.g., rotary and rotary combined with an up/down movement).

Housing 10 preferably includes a vibration mechanism (not shown) for imparting a vibratory motion to, at least, bottom wall 15. It will be appreciated by those skilled in the art that any known method suitable for generating a vibratory motion in a foot spa may be used in foot spa 5 and are thus within the scope of the present invention. The vibration mechanism preferably and selectively imparts vibratory motion to the foot spa independently of whether water is disposed in the reservoir and any other operational functions are activated.

Housing 10 preferably has a splash guard 50 removably secured to top wall 25, for covering, at least partially, the reservoir. Splash guard 50 aids in the containment of water in foot spa 5 when water is deposited therein. Containment of the water within the reservoir can be an important concern during the filling and emptying of water from foot spa 5. Additionally, splash guard 50 aids in the containment of water within the reservoir during a transport of the portable foot spa 5.

Cover 50 also provides a support surface for foot spa stimulus/treatment attachments such as, for example, loofah disk(s) 80. A pair of loofah disks are shown in FIGS. 1 and 2 attached to the top surface of splash guard 50. Loofah disks 80 are preferably removably attached to splash guard 50.

It should be appreciated that foot spa stimulus/treatment attachments and sources of stimulus other than loofah disks 80 may be disposed on and/or attached to splash guard 50. Other such foot spa stimulus/treatment attachments and sources of stimulus (i.e., stimulus delivery system) may include, for example, a therapeutic heated surface, a massage stone, a therapeutic energy source such as radiant heat, infrared, magnetic wave, and ionic sources.

In another aspect hereof, the foregoing foot spa stimulus/treatment attachments and sources of stimulus may be disposed on and in upper walls 25.

Water deposited in foot spa 5 is optionally circulated by a motor driven pump (not shown) housed in the interior of housing 10. The pump draws water from the reservoir into the pump through an inlet and expels water into the reservoir in a “jetting” action through a water jet 85. The pump used by foot spa 5 may include any number or variety of pumps suitably sized and rated for application in the foot spa of the present invention.

Water jet 85 preferably has a plurality of outlets 87 that may be selectively positioned (i.e., adjusted) and directed in a desired direction. Water jet outlets 87 are preferably adjustable in at least up, down, left, and right directions. Water jet 85 is supplied water via, for example, a four output manifold in the embodiment of FIGS. 1 and 2. Additional water jets 85 ca be provided in foot spa 5. The position of water jet 85, whether one or multiples, may be varied to target jetting water to specific locations of the reservoir.

Foot spa 5 has an aeration system that includes a liquid circulation network having the pump discussed above, and one or more venturi mixers (not shown), all preferably retained in the portion of housing 10 located underneath heel rest 45. The circulation network has aeration outlets 35 opening into the reservoir. Air is preferably drawn into foot spa 5 via an air inlet(s) located on the bottom of foot spa 5, with water being drawn from the reservoir via a water inlet in the reservoir.

Air and water is provided to the venturi mixers by a network of pipes or a connection in air/fluid communication with the air and water inlets. The water/air mixture is routed to the aeration outlets 35 for the provisioning of invigorating air bubbles into the reservoir.

In an embodiment of the present invention, operation of foot spa 10 is greatly enhanced by touchpad control unit 60. Touchpad control unit 60 includes touch-sensitive controls 65 and associated circuitry for controlling the various operational functions of foot spa 5.

In one aspect of the present invention, touch-sensitive controls 65 are backlit to provide a functional and/or aesthetic benefit. Backlighting touch-sensitive controls 65 provides a clear indication of the location of the touch-sensitive controls 65, even in low light settings. Backlighting touch-sensitive controls 65 also provides a pleasing, soothing appearance that further enhances the therapeutic massaging experience provided by foot spa 5.

Touch-sensitive controls 65 are preferably operated by a light touch. Thus, significant dexterity and force are not required to actuate touch-sensitive controls 65. Touch-sensitive controls 65 may include mechanical micro-switches or electronic sensors, and a combination thereof.

In an aspect of the present invention, touch-sensitive controls 65 are resistant to environmental elements such as moisture and debris. The moisture resistance, for example, may be provided by enclosing, at least partially, touch-sensitive controls 65 in a moisture impenetrable and wear resistant covering. Such a covering may totally encapsulate touch-sensitive controls 65, individually or collectively, or encapsulate a portion of the controls such as that portion exposed for actuation.

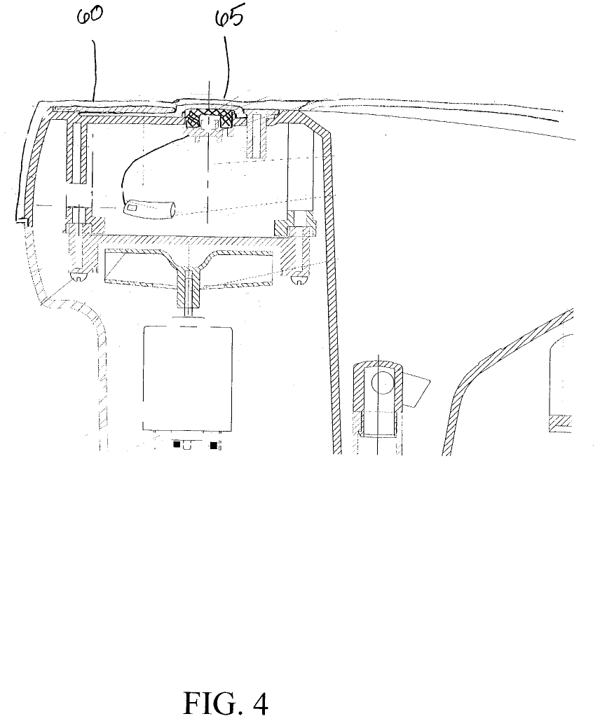

In accordance with the touch-sensitive benefits discussed above, the covering of touch-sensitive controls 65 is preferably pliable. A cross-sectional view of an exemplary touch-sensitive control 65 assembly is shown in FIG. 4. As shown, touch-sensitive control 65 of touchpad 60 has an outer covering that protects and seals the mechanical and electrical components of touch-sensitive controls 65 from moisture and other environmental elements.

Referring to touchpad control unit 60 of FIG. 2, there is depicted three touch-sensitive controls 65. As shown, touchpad 60 is preferably angled to present the touch-sensitive controls thereof at a user-friendly and convenient angle to the user. The three touch-sensitive controls 65 correspond to operational functions of foot spa 5. In one embodiment, the three touch-sensitive controls 65 correspond to (a) a vibration and heat function, (b) a water jet function, and (c) a bubbles and heat function. In brief, vibration and heat function (a) of touch-sensitive control 65 is sequentially depressed to activate/deactivate the vibration and heat function of foot spa 5. Water jet function (b) of touch-sensitive control 65 is sequentially depressed to activate/deactivate the water jet function of foot spa 5. Bubbles and heat function (c) of touch-sensitive control 65 is sequentially depressed to activate/deactivate the aerated bubbling and heat function of foot spa 5.

In an aspect hereof, the three touch-sensitive controls 65 may be actuated alone or in combination to yield multiple modes of operation. For example, the depicted touch-sensitive controls 65 may be actuated in the following seven permutations: 1) function (a) only; 2) function (b) only; 3) function (c) only; 4) functions (a)+(b); 5) functions (a)+(c); 6) functions (b)+(c); and 7) functions (a)+(b)+(c).

Touch-sensitive controls 65 may control other operational functions such as, for example, a vibrate only function, a timed operational sequence of predetermined or random stimulus delivery systems (e.g., heat, bubbles, infrared, ionic, sonic, etc.) incorporated into foot spa 5, and a master on/off switch.

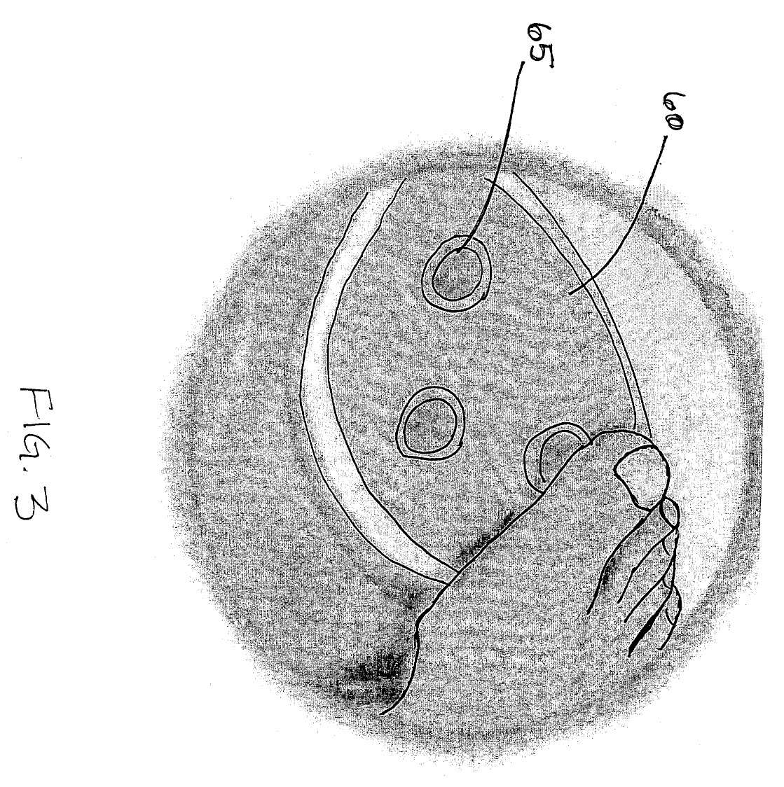

In accordance with the present invention, touch-sensitive controls 65 may, for example, be actuated by the user's foot. Referring to FIG. 3, there is depicted an example of a foot being used to selectively operate the various features of foot spa 5 by selectively actuating touch-sensitive controls 65. Touch-sensitive controls 65 are appropriately spaced, positioned, and sensitive to allow easy actuation thereof by the user's foot. Since touch-sensitive controls 65 are touch-sensitive, that is, they do not require much force to actuate, they are easily and effectively manipulated by the user's foot. For example, touch-sensitive controls 65 do not require the user to turn a control knob or switch.

Thus, the user of foot spa 5 can control (i.e., change) the various operations of the foot spa without impeding the relaxing context induced by operation of the foot spa by simply changing operational modes with a light touch of the foot. Accordingly, foot spa 5 may be effectively and efficiently operated, even with a wet foot recently removed from the reservoir. Additionally, concerns regarding the longevity of touch-sensitive controls 65 are also obviated by the moisture-resistant attributes of touch-sensitive controls 65.

It should be appreciated that the function controls discussed above are exemplary of the foot spa of the present invention and do not preclude the inclusion, exclusion, and combination of other foot spa function controls.

It should also be appreciated by those skilled in the art that the particular foot spa functions and other aspects of the teachings herein are but examples of the present invention. Thus, they do not limit the scope or variety of applications that the present invention may be suitably implemented. Thus, it should be understood that the foregoing description is only illustrative of a present implementation of the teachings herein. For example, the foot spa of the present invention may include a remote control unit and receiver for remotely controlling the operational functions of the foot spa. In such an embodiment, the touch-sensitive controls of the touchpad control would preferably retain the ability to fully control the operational functions of the foot spa. Various alternatives and modification may be devised by those skilled in the art without departing from the invention. Accordingly, the present invention is intended to embrace all such alternatives, modifications, and variances.

What is claimed is:

1. A foot spa comprising:
a portable housing defining a reservoir for locating feet; and
a touchpad control having touch-sensitive controls for controlling an operational function of said foot spa disposed on an upper surface of said portable housing.

2. The foot spa of claim 1, wherein said portable housing comprises a front sidewall wall, a rear sidewall wall and opposing side walls, and said touchpad control is disposed on said an upper portion of said front sidewall.

3. The foot spa of claim 1, wherein said operational function is a program function for executing at least one function of said foot spa.

4. The foot spa of claim 3, wherein said program function executes a plurality of functions associated with said foot spa in an automated sequence.

5. The foot spa of claim 1, wherein said operational function is selected from the group consisting of vibration, water jets, bubbles, heat, infrared, stone therapy, ionic, and a combination thereof.

6. The foot spa of claim 1, wherein said touchpad control comprises a pliable water-resistant covering for sealing said touch-sensitive control against a penetration of water.

7. A method of operating a foot spa, said method comprising:
selectively actuating, with a foot, a touchpad control touch-sensitive control for controlling an operational function of said foot spa wherein said touchpad control is disposed on an upper surface of said portable housing.

8. The method of claim 7, wherein said selectively actuating is accomplished without a requirement of turning control.

9. The method of claim 7, wherein all of said operational functions of said foot spa are controlled by said selectively actuating.

10. The foot spa of claim 1, wherein said operational function is selected from the group consisting of vibration, water jets, bubbles, heat, infrared, stone therapy, ionic, and a combination thereof.
